(19) United States
(12) Patent Application Publication
(10) Pub. No.: US 2024/0368479 A1
(43) Pub. Date: Nov. 7, 2024

(54) CATALYST ASSISTED PYROLYSIS PROCESS FOR CONVERTING MIXED PLASTIC WASTE TO FUELS

(71) Applicant: PACT FUEL, LLC, Darien, CT (US)

(72) Inventors: Juzer JANGBARWALA, Chino Hills, CA (US); Aram SARKISSIAN, Santa Clarita, CA (US)

(21) Appl. No.: 18/580,753

(22) PCT Filed: Jul. 22, 2022
(86) PCT No.: PCT/US2022/038063

§ 371 Date: Jan. 19, 2024

Related U.S. Application Data
(60) Provisional application No. 63/225,460, filed on Jul. 24, 2021.

(51) Int. Cl. C10G 9/00; B01J 23/02; B01J 23/745; B01J 29/70; C10G 55/04

(52) U.S. Cl. CPC C10G 9/002; B01J 23/02; B01J 23/745; B01J 29/7003; C10G 55/04; C10G 2300/1003

(57) ABSTRACT

Processes and systems for making desired alkane fuels, including solid, liquid, and gas hydrocarbon fuels, from mixed plastics feedstock, are provided, which processes integrate at least three pyrolysis stages with one or more other processing units. For example, catalytic reactors may be used with specific catalysts to drive the cracking process to the chain length of the desired hydrocarbon fuel product. Further separation of the desired hydrocarbon fraction may be achieved by fractional condensers. The plastics cracking processes of this disclosure may function with little or no external energy inputs.

### FIELD

The invention relates to pyrolysis processes for converting waste composed of a mixture of plastic materials to a narrow range of hydrocarbon fuels with the assistance from catalysts.

### BACKGROUND

Evidence is mounting that the chemical building blocks that make plastics so versatile are the same components that might harm people and the environment, and the production and disposal of plastics contribute to an array of environmental problems. For example, chemicals added to plastics are absorbed by human bodies. Some of these compounds have been found to alter hormones and/or may have other potential human health effects. Plastic debris, laced with chemicals and often ingested by marine animals, can injure or poison wildlife. Floating plastic waste, which can survive for thousands of years in water, serves as a mini transportation mechanism for invasive species, disrupting habitats. Plastic buried deep in landfills can leach harmful chemicals that spread into groundwater. Around 4 percent of world oil production is used as feedstock to make plastics, and a similar amount is consumed as energy in the process.

Cities around the country are no longer recycling many types of plastic dropped into recycling bins. Rather, they are being landfilled, burned or stockpiled. City officials around the country view vast quantities of plastic as no better than garbage. The “market conditions” with regard to plastic waste, has changed because China, once the largest buyer of plastic waste, shut its doors to all but the highest quality plastics in 2017.

As municipalities are forced to deal with their own plastics trash instead of exporting it, they are discovering that much of this plastic is at the end of its life cycle (i.e., unrecyclable). The issue is with a popular class of plastics that people have traditionally been told to put into their recycling bins—a hodgepodge of items such as clamshell-style food packaging, black plastic trays, take-out containers, and cold drink cups, which the industry dubs “mixed plastic.” There are virtually no domestic manufacturers that want to buy this waste to recycle it or turn it into something else.

In some parts of the US, recycling facilities are separating “mixed plastics” from those plastics that still retain value, such as water bottles, laundry detergent bottles, and milk jugs, and contrary to what customers expect, sending them directly to a landfill or incinerator. “Mixed plastics” is a broad category that can include everything from car bumpers to five-gallon buckets from big box stores to food containers. The recycling business depends on someone willing to buy the materials that recyclers are selling. Unfortunately, there are very few US or foreign markets for mixed plastics, most of which are the plastics that are collected in residential recycling bins, and it is therefore much less expensive for municipalities to landfill their mixed plastic waste. In fact, some recycling facilities are stockpiling tons of mixed plastics in hopes that some kind of domestic market/demand will eventually return.

Plastic buried deep in landfills can leach harmful chemicals that can spread into groundwater. Incineration, including gasification, pyrolysis, plasma arc, etc is not conventionally considered a viable solution for handling plastic pollution and is in fact considered to be harmful. For example, incineration can generate chemicals that are considered major criteria GHGs (Greenhouse Gas) emissions, and are therefore considered climate relevant. Incineration is also associated with the release of CO₂, CO, nitrous oxide (N₂O), ammonia (NH₃), and other nitrogen oxides (NOx). Dioxins and other chemicals can also be released during incineration. In fact, one ton of municipal solid waste has been associated with the (minimal) release of 700 kg CO₂. Further, there exists a variety of heavy metals that are present in incineration units' feedstock materials that will be in the incineration bottom ash or released as major pollutants from the exhaust system.

For example, Korean Patent KR101289583B1 outlines multiple pyrolysis chambers, but with the intended function of using the multiplicity for operating as multiple units (one or more operating while one or more are being cleaned) but still having the primary approach to pyrolysis as a single, one-pot stage.

Therefore, there remains a need for processes capable of destroying plastic waste materials that can also convert plastic waste materials to more valuable and desirable products, such as fuels that can be used as an energy source for these processes or valuable commercial products.

### SUMMARY

The processes of this disclosure utilize a unique combination of techniques to economically produce high quality fuels from plastics waste. These processes can control the range of hydrocarbon fuels produced using catalysts combined with 3-staged decomposition reactor designs. In these processes, two different methods of using use catalysts are effective: 1) as a direct feed (consumable) integrated with the plastic waste feedstock; and 2) as a post-pyrolysis cracking method to crack pyrogas to the desired range of hydrocarbon fuels. As described above, other pyrolysis processes typically employ a single pyrolysis stage for producing “pyro gas.” In contrast, the processes of this disclosure include at least three discreet steps performed in succession. The presence of multiple pyrolysis stages in succession is distinctly different from other pyrolysis systems, described above, which are designed with multiple pyrolysis chambers. In the pyrolysis processes of this disclosure, each stage is designed for a set of specific functions that reduce waste, increase recovery, and allow the flexibility to produce target fuels with a narrower range of carbon chains than can be achieved by single step pyrolysis.

“Fast pyrolysis” is defined as a process whereby the temperature is raised to the desired temperature at a very rapid rate. “Slow pyrolysis” is defined as the opposite, wherein the temperature rise profile is much slower. There are many benefits attached to both fast and slow pyrolysis approaches. A benefit of the pyrolysis processes of this disclosure is the multiple pyrolysis stages, resulting in the ability to conduct and control hybrid temperature rise profiles. Thus, the processes of this disclosure, by default, become a combination of both fast and slow pyrolysis. By staging the temperature rise through at least three temperature zones, the pyrolysis systems of this disclosure simulate a slow pyrolysis overall, with a typical total system retention time of about 60-90 minutes, or longer, but with intervening pyrolysis stages having a rapid rise in temperature, akin to fast pyrolysis.

Thus, this disclosure provides methods of processing plastic waste. These methods include volatilizing light organics from plastic waste in a pre-conditioning chamber (PCC) maintained at a temperature between about 150° C. and about 225° C. to form a mixed plastic liquid. The mixed plastic liquid from the PCC is directed to a first pyrolysis chamber maintained at a temperature between about 250° C. and about 400° C. to form a homogenized plastics mixture. The homogenized plastics mixture from the first pyrolysis chamber is directed to a second pyrolysis chamber maintained at a temperature between about 300° C. and about 500° C. to form a partially cracked plastic mixture. The partially cracked plastic mixture from the second pyrolysis chamber is directed to a third pyrolysis chamber maintained at a temperature between about 400° C. and about 600° C. to form a pyrogas comprising longer chain alkanes (typically in the range of C₁₂-C₃₀ alkanes). Pyrogas from the third pyrolysis chamber is directed into at least one of three catalytic reactors to produce a hydrocarbon stream from each of the at least three catalytic reactors. Each of these catalytic reactors contains a different catalyst. Hydrocarbons from the at least three catalytic reactors are directed into a series of at least three fractional condensers to form a light hydrocarbon vapor. Each of the least first, second, and third fractional condensers are connected in series. The light hydrocarbon vapor from the third fractional condenser is fed to a chilled water condenser to produce a pyrogas composed primarily of non-condensable hydrocarbon gases (C₁-C₄ alkanes).

In these methods, inorganic halogen ions may be emitted as HCl or HF gases in the PCC. The PCC may be swept with a sweep gas (such as nitrogen (N₂)) to expel halogen acid gases. The PCC may include one or more gas vents. Waste vapors may be vented from the PCC through the one or more gas vents. Waste vapors may be contacted with an adsorbent, such as a polystyrene crosslinked with divinylbenzene, which may be functionalized with tertiary amine group. The adsorbent may be in a housing jacketed with a cooling loop to maintain the temperature of the adsorbent below about 50° C. The adsorbent may be moistened with a periodic feed of water. The adsorbent may be regenerated by contacting the adsorbent with a basic liquid, such as dilute NaOH.

In these methods, the second pyrolysis chamber may include a mixer, such as an auger, that mixes the homogenized plastics mixture. The temperature in the second pyrolysis chamber may be maintained at a temperature between about 350° C. and about 450° C., or a temperature between about 375° C. and about 425° C. A pyrogas comprising lower molecular weight alkane (C₁ to C₄) fuels may be extracted from the second pyrolysis chamber. One or both of CO₂ and CO may be recovered from the second pyrolysis chamber.

In these methods, the third pyrolysis chamber may be maintained at a temperature between about 450° C. and about 550° C., or at a temperature between about 475° C. and about 525° C. The third pyrolysis chamber may include a gas vent to remove any fugitive vapors.

In these methods, any one or all of the first, second, and third pyrolysis chambers may include a gas vent fluidly connected to a common manifold.

In these methods, the combined gas from the manifold pyrogas from the third pyrolysis chamber, or combined gas from the manifold, may be filtered through a heated ceramic filter, to form a filtered pyrogas stream.

In these methods, at least one of the catalytic reactors may contain a catalyst selected from the group consisting of FeO, Fe₂O₃, CaO, CaCO₃, MgO, Al₂O₃, ZnO, and Zeolites 5A.

In these methods, each of the at least first, second, and third fractional condensers comprise a recirculating fluid maintained at a temperature that classifies a heavy, medium, and light fraction dew point (typically about 360° C. to about 400° C., about 250° C. to about 360° C., about 100° C. to about 250° C., respectively), such that a fraction with boiling points lower than the temperature of the recirculating bath in each fractional condenser leaves the fractional condenser as a gas, and a fraction with boiling points higher than the recirculating fluid condenses and increases the volume of the recirculating fluid. The recirculating fluid may be gravity drained from a fractional condenser to a holding tank.

In these methods, each of the at least a first, second, and third fractional condensers comprise two packed columns connected in series, wherein gas is fed into the bottom of a first column and exits the top of a second column.

In these methods, the first fractional condenser may recirculate a fluid at a temperature range of about 300° C. to about 400° C., or at a temperature range of about 350° C. to about 370° C. Waxes may be condensed in the first fractional condenser. The waxes may be recycled back to the third pyrolysis chamber.

In these methods, the second fractional condenser comprises a recirculating fluid maintained at the temperature of a desired paraffin (typically about 250° C. to about 360° C.). The recirculating fluid in the second fractional condenser may be maintained at the temperature of aromatic hydrocarbons and other light fractions.

In these methods, the third fractional condenser may have a recirculating fluid maintained at the temperature of between about 160° C. and about 250° C.

In these methods, the chilled water condenser may be maintained at a temperature of about 5° C. The pyrogas from the chilled water condenser may include C₁ to C₄ hydrocarbon compounds. The pyrogas from the chilled water condenser may include non-condensable gases (NCGs). The pyrogas from the chilled water condenser may include at least one gas selected from hydrogen, methane, ethane, propane, and butane.

In these methods, at least part of the pyrogas from the chilled water condenser may be fed to a flex fuel turbine to generate electrical power and waste heat.

In these methods, at least part of the pyrogas from the chilled water condenser may be fed to fuel a low NOx burner to generate heat. Heat from a heat distribution chamber from a fire box from the low NOx burner may be allocated to a Proportional Integral Derivative (PID) thermostat loop. Heat may be distributed via the PID thermostat loop to at least one of the three pyrolysis chambers, at least one catalytic reactor, and the chilled water condenser.

A related aspect of this disclosure provides a method of processing mixed plastic waste that includes almost all of the processing methods and stages of the processes described above, but eliminates the use of the at least three catalytic reactors by adding an inorganic catalytic material directly to the mixed plastic feed prior to the first pyrolysis stage to facilitate simultaneous pyrolysis and cracking reactions. Light organics are volatilized from the mixed plastic feed in a pre-conditioning chamber (PCC) maintained at a temperature between about 150° C. and about 225° C. to form a mixed plastic liquid. The mixed plastic liquid is directed from the PCC to a first pyrolysis chamber maintained at a temperature between about 250° C. and about 400° C. to form a homogenized plastics mixture. The homogenized plastics mixture from the first pyrolysis chamber is directed to a second pyrolysis chamber maintained at a temperature between about 300° C. and about 500° C. to form a partially cracked plastic mixture. The partially cracked plastic mixture from the second pyrolysis chamber is directed to a third pyrolysis chamber maintained at a temperature between about 400° C. and about 600° C. to form a pyrogas comprising C₁₂-C₂₆ alkanes. Pyrogas from the third pyrolysis chamber is directed to a first of at least a first, second, and third fractional condenser to form a light hydrocarbon vapor, wherein each of the at least first, second, and third fractional condensers are connected in series. The light hydrocarbon vapor from the third fractional condenser is fed to a chilled water condenser to produce a pyrogas.

This Summary is neither intended nor should it be construed as representative of the full extent and scope of the present disclosure. Moreover, references made herein to “the present disclosure,” or “this disclosure” or aspects thereof, should be understood to mean certain embodiments of the present invention and should not necessarily be construed as limiting all embodiments to a particular description. The present invention is set forth in various levels of detail in this Summary as well as in the attached figure and the Detailed Description and no limitation as to the scope of the present invention is intended by either the inclusion or non-inclusion of elements, components, etc. in this Summary. Additional aspects of the present invention will become more readily apparent from the Detailed Description, particularly when taken together with the figure.

### FIGURES

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a process diagram illustrating a pyrolysis process embodiment of this disclosure.

FIG. 2 is a process diagram illustrating another pyrolysis process embodiment of this disclosure.

### DETAILED DESCRIPTION

Reference will now be made in detail to particular embodiments of compositions and methods. The disclosed embodiments are not intended to be limiting of the claims.

This disclosure generally relates to processes and systems for treating plastic waste to produce high value products, such as fuels. These processes may include sorting and washing waste plastics intended as feedstock for the processes and systems of this disclosure to remove labels, dirt, etc. The desired type of plastics from the sorted plastics is fed to a pyrolysis system of this disclosure for conversion to energy. The most desired type of plastics for producing high quality liquid fuels using the processes described herein include High Density Polyethylene (HDPE), Low Density Polyethylene (LDPE), Polypropylene (PP), Polyethylene (PE), and Polystyrene (PS).

In preparation for the first stage of the pyrolysis processes of this disclosure, a conveyor typically drops the plastics through a knife gate valve. The valve may lead directly to the first stage of these pyrolysis processes, a “pre-conditioning chamber” (PCC), typically maintained at a temperature between about 150° C. and about 225° C. The PCC may be maintained within a low temperature range to volatilize very light organics, such as inks, mold release lubricants, and the like. If any halogenated plastics (such as PVC) have inadvertently been fed into the system, the inorganic halogen ions may be emitted as HCl or HF gases in the PCC. The PCC also acts as a melting stage for the plastics forming a mixed plastic liquid in the PCC that is directed to a first pyrolysis chamber. The PCC may be equipped with a source of a sweep gas (such as N₂) to facilitate expulsion of the halogen acid gases.

One or more gas vents may be provided in the PCC to remove waste vapors, including volatilized light organic and acid gas mixtures. The waste vapor combined with the sweep gas may be sent to an adsorbent with dual functionality that can adsorb the typically low levels of organic vapors and act as a weak base anion exchange medium to neutralize acid gases. Examples of useful adsorbents include carbonized polystyrenes crosslinked with divinylbenzene (e.g., Purolite™ MN 202 and MN 270), that may be functionalized with tertiary amine groups. The weak base functionality of the adsorbent neutralizes acids by exchanging the halogen ions for hydroxide (OH—) anions. The housing for the adsorbent may be jacketed with a cooling loop to maintain the temperature of the media below about 50° C. The internal media may also be kept moist with a periodic feed of water. The polymeric adsorbents can be regenerated on site using a basic liquid, such as dilute NaOH or, to eliminate direct waste discharge from the production site, may be exchanged as cylinders and regenerated off site.

Mixed plastic liquid from the PCC is directed to a first pyrolysis chamber, wherein the temperature of the first pyrolysis chamber is typically maintained at a temperature between about 250° C. and about 400° C., or between about 250° C. and about 350° C., or between about 275° C. and about 325° C. The first pyrolysis chamber may be equipped with an auger type mixing shaft. The primary function of this first pyrolysis chamber is to homogenize the mixed plastic liquid from the PCC forming a homogenized plastics mixture. The homogenized plastics mixture in the first pyrolysis chamber acquires average thermodynamic qualities of melted plastics, such as latent heat, decomposition temperature, and the like.

The homogenized plastics mixture then overflows to a second pyrolysis chamber, which may also have a mixer (such as an auger) to mix the homogenized plastics mixture. The second pyrolysis chamber brings the liquid plastic mixture rapidly to a partial decomposition stage. The temperature in the second pyrolysis chamber is typically maintained between about 300° C. and about 500° C., or between about 350° C. and about 450° C., or between about 375° C. and about 425° C. This second pyrolysis chamber eliminates elements in the homogenized plastics mixture to produce a molten product with desirable qualities required for producing primarily straight chain (alkane) carbon fuels. For mixed plastic waste, this second pyrolysis is useful in extracting consistent quality fuel products. The homogenized plastic mixture subjected to the temperature range in this second pyrolysis partially cracks at the low binding energy sites, such as double bonds to form a partially cracked plastic mixture. This second pyrolysis chamber thus extracts from the homogenized plastic mixture a pyrogas composed mainly of lower molecular weight alkane (C₁ to C₅) fuels, including double bonded or aromatic structures. This second pyrolysis may also remove oxygen molecules from the plastics, as CO₂ or CO. Partially cracked plastics remaining in the second pyrolysis chamber are directed to a third pyrolysis stage devoid of oxygen and portions that are thermodynamically unstable.

The partially cracked plastic mixture from the second pyrolysis is thus substantially free of contaminants, such as oxygen and other elements bonded tightly in the polymer matrix.

The partially cracked plastic mixture is directed into a third pyrolysis stage where complete pyrolysis is initiated by a fast increase in temperature, i.e., fast pyrolysis.

The third pyrolysis chamber is operated between about 400° C. and about 600° C., or between about 450° C. and about 550° C., or between about 475° C. and about 525° C. At these higher temperatures, the partially cracked plastic mixture from the second pyrolysis stage mainly converts to a pyrogas composed of longer chain alkanes (typically C₁₂-C₂₆ alkanes). The pyrogas produced in this third pyrolysis stage can be catalytically cracked with high selectivity to produce a high yield of specific carbon chain length alkanes.

The four stages described above (PCC and three pyrolysis stages) are engineered to produce a consistent feed to the final catalytic stage to give high yields of a desired fuel product. All the pyrolysis chambers may be fluidly connected to allow the plastics liquid to overflow to the next chamber. Each pyrolysis chamber may also be equipped with gas vents fluidly connected to a common manifold, although minimal pyrogas is generated from the first two pyrolysis chambers. The vent(s) in these chambers are provided to remove any fugitive vapors.

The pyrogas from the three pyrolysis chambers may be filtered through a heated ceramic type self-cleaning filtration mechanism to form a filtered pyrogas stream. The filtration mechanism captures particles in the gas from either the impurities in the feedstock or by thermal degradation of the plastic to carbon particles.

Pyrogas from the pyrolysis chambers is fed to one of three catalytic reactors, depending on the desired fuel product. Each catalytic reactor operates with a different catalyst (such as FeO, Fe₂O₃, CaO, CaCO₃, MgO, Al₂O₃, ZnO, Zeolites 5A, or others) and operating conditions designed specifically to produce the desired fuel product with high selectivity, conversion, and yield.

Each of the catalytic reactors will produce a mixture of hydrocarbons and further separation of the desired hydrocarbon fraction is achieved by fractional condensers. The fractional condensers use a recirculating stream of heated liquid at a temperature that classifies a heavy, medium, and light fraction dew point (typically about 360° C. to about 400° C., about 250° C. to about 360° C., about 100° C. to about 250° C., respectively). Hence the fraction with boiling points lower than the temperature of the recirculating bath leave the fractional condenser as a gas, and the fraction with boiling points higher than the recirculating fluid condense and increase the volume of the recirculating liquid. The condensed volume recirculating liquid may be gravity drained to a holding tank. Each fractional condenser has two packed columns in series wherein gas is fed into the bottom of the first column and exits the top of the second column. Thus, the condensing stages are configured as follows:

The first fractional condenser recirculates a fluid at a temperature range of about 300° C. to about 400° C., or about 350° C. to about 370° C. Undesired hydrocarbon by-products of the catalytic considered “heavy fractions,” such as waxes, are condensed. Waxes may be stored in a dedicated tank and either sold as sulfur-free wax or recycled back to a third pyrolysis chamber where they get converted to vapor and mixed with the pyrogas produced in that third pyrolysis chamber.

Vapor from the second column of the first fractional condenser is fed to a second fractional condenser where the recirculating fluid (typically an oil) is maintained at the temperature of the desired paraffin. The desired paraffin is condensed and overflows to a dedicated product tank, similar to the wax storage tank from the first fractional condenser.

Vapor from the second column of the second fractional condenser is fed to a third fractional condenser where the recirculating oil is at the temperature of aromatics and other light fractions. The recirculating fluid temperature in this third fractional condenser is typically maintained between about 160° C. and about 250° C. The condensed aromatics are stored in a dedicated storage tank and may be used to blend with the desired fraction to fine tune the flash point and other physical characteristics of the desired alkane product.

Vapor from the second column of the third fractional condenser is fed to a fourth condenser that is cooled by a chilled water loop maintained at a temperature of about 5° C. The very light hydrocarbon fractions (C₅-C₆) are condensed in this chilled water condenser. The condensed hydrocarbon stream from this chilled water condenser (mostly C₅-C₆ compounds) may be stored in a dedicated storage tank and utilized to either blend with the desired fraction to fine tune the flash point and other physical characteristics of the desired alkane product, or sold as high value products to the chemical processing industries.

Vapor from the chilled water condenser will be a pyrogas essentially composed of non-condensable gases (NCGs) such as hydrogen, methane, ethane, propane, butane, and light aromatics. This gas may be sent to a compressor, stored in a pressurized storage tank, and/or subsequently used as fuel to generate energy for these processes.

The plastics cracking processes of this disclosure may function with little or no external energy inputs. For example, part of the NCGs may be used as feed to a flex fuel turbine to generate electrical power and waste heat. The electrical power may be utilized to power motors, mixers, instrumentation, and startup resistive heating for the condensers.

Alternatively or additionally, part of the NCGs produced may be utilized to fuel a low NOx burner to generate heat. A fire box from the low NOx burner may be equipped with a heat distribution chamber, and heat can be allocated from this chamber via control valves and a Proportional Integral Derivative (PID) thermostat loop for each of the process steps that require heat. This chamber then distributes heat on demand to the PCC, all three pyrolysis chambers, catalytic reactor(s), and/or an absorption chiller for the chilled water condenser. The thermal energy input circuit minimizes emissions and maximizes fuel efficiency.

The exit gas from the heating chambers may again be recycled in a manner commonly known in the burner industry as Exhaust Gas Recycle (EGR). There are multiple advantages with respect to energy recovery known to those of skill in the art, including more control of temperatures.

Notably, the highest percentage of condensed product will typically be produced in the second fractional condenser, wherein about 90% of the total condensed product is recovered. The lighter and heavier fractions typically form minor fractions, but their separation gives a high level of control to meet target fuel specifications either by mixing them back in controlled proportions or removing them altogether.

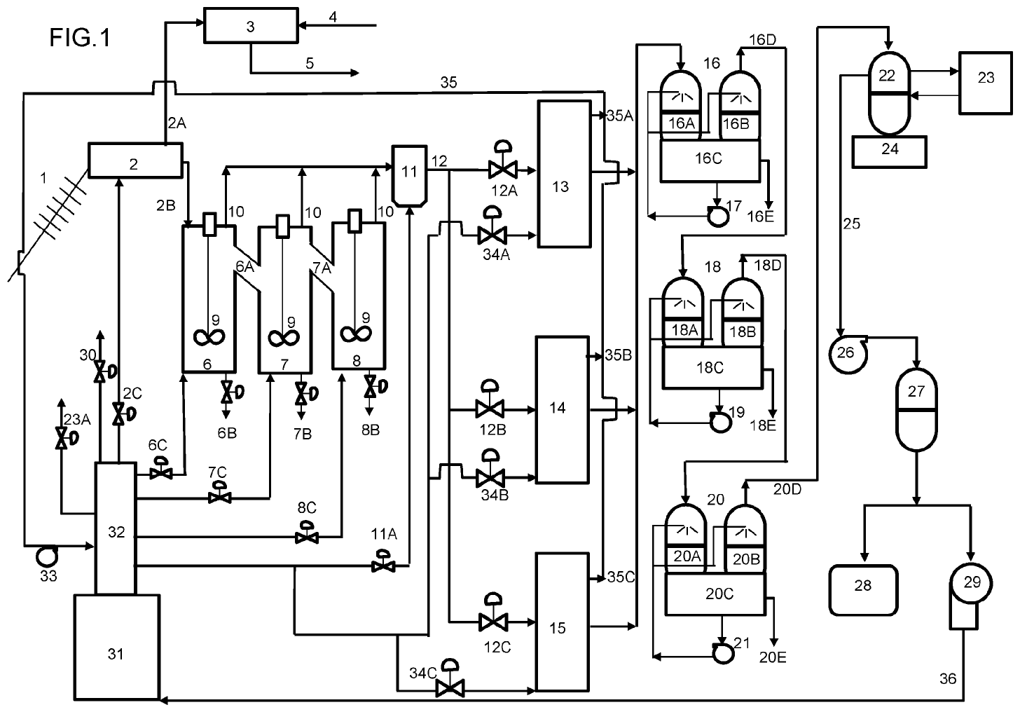

The processes of this disclosure will be better understood with reference to FIG. 1, which is a process diagram illustrating a pyrolysis process embodiment of this disclosure. Presorted, prewashed, and pre-shredded plastic, typically to size less than 1 inch in the largest dimension, is fed into the system via a conveyor belt (1). PCC chamber (2) is maintained at a temperature sufficient to take the plastic beyond its glass transition temperature (typically about 175° C. to about 225° C.), but less than its vaporization temperature, resulting in a flowing, albeit viscous, fluid. Vent (2A) removes any volatile gases that are not beneficial to the process, such as Cl (as HCl) and F (as HF) resulting from heating halogenated plastics, such as PVCs. A jacketed vessel (3), containing functionalized polymeric adsorbent, is fluidly connected to cooling water loop (4). The adsorbent may be removed (5) and replaced periodically. The adsorbent has a weak base functionality that neutralizes the acidic gas, and the low level of organic vapors are adsorbed by the carbonaceous backbone. After removal (5), the adsorbent may be regenerated off site.

From PCC chamber (2) the liquified plastic waste (2B) is fed into pyrolysis chambers (6,7,8). Mixers/augers (9) keep the liquid plastic mixed in each pyrolysis chamber (6,7,8). Melted plastic flows from pyrolysis chamber (6) to each successive pyrolysis chamber (7,8) by overflow. From the first pyrolysis chamber (6) the liquid plastics mixture overflows to the second pyrolysis chamber (7) via an overflow channel (6A), and from second pyrolysis chamber (7) to third pyrolysis chamber (8) via overflow channel (7A).

Pyrolysis chambers (6,7,8) are each equipped with drains (6B,7B,8B, respectively) to clean the pyrolysis chambers (6,7,8) and evacuate any solids settled in pyrolysis chambers (6,7,8). Such solids may result from non-volatile additives added for the processing of the original plastics.

Pyrolysis gas (10) resulting from pyrolysis chambers (6,7,8) combines and is directed to a high temperature ceramic type particulate filter (11). Filtered pyrogas (12) from ceramic type particulate filter (11) is selectively transferred through one or more of valves (12A,12B,12C) to at least one of the catalytic reactors (13,14,15) to produce a high concentration of the desired final alkane product. The three catalytic reactors (13,14,15) are provided with specific catalysts to drive the cracking process to the desired chain length of the hydrocarbon fuel product. By controlling temperatures and specific catalysts in each catalytic reactor, the desired final product may be produced in three “cuts” or fractions: for example, jet fuel or kerosene may be captured from catalytic reactor (13); naphtha or gasoline may be captured from catalytic reactor (14); and diesel fuel may be captured from catalytic reactor (15). Though the major portion of the product streams from these catalytic reactors are the desired fuel products, small fractions of other mixed hydrocarbons may be present in the product gases.

To further separate product fractions from the mixed hydrocarbons in the product gases, a cascading fractional condenser system comprising fractional condensers (16,18,20) is deployed. Fractional condenser (16) includes two counter current packed bed columns in series (16A and 16B) and a heated oil chamber (16C) with recirculation pump (17) to spray the controlled temperature oil in the counter current packed bed columns (16A and 16B). Fractional condenser (16) condenses the heavy fractions, such as waxes, by maintaining the scrub oil temperature between about 350° C. to about 380° C. As the gas condenses, the volume in tank (16C) increases and overflow (16E) may be sent to one or more additional holding tank(s), not shown.

Uncondensed gas (16D) from fractional condenser (16) is sent to fractional condenser (18). Fractional condenser (18) includes two counter current packed bed columns in series (18A and 18B) and heated oil chamber (18C) with recirculation pump (19) to spray the controlled temperature oil in packed bed columns (18A and 18B). Fractional condenser (18) condenses the paraffin fraction (in this embodiment, a desired product fraction) by maintaining the scrub oil temperature between about 300° C. and about 360° C. As the gas condenses, the volume in heated oil chamber (18C) increases and overflow (18E) may be sent to one or more holding tank(s), not shown.

Uncondensed gas (18D) from fractional condenser (18) is sent to fractional condenser (20). Fractional condenser (20) includes two counter current packed bed columns in series (20A and 20B) and heated oil chamber (20C) with recirculation pump (21) to spray the controlled temperature oil in counter current packed bed columns (20A and 20B). Fractional condenser (20) condenses higher boiling point aromatics by maintaining the scrub oil temperature between about 160° C. and about 300° C. As the gas condenses, the volume in heated oil chamber (20C) increases and overflow (20E) may be sent to one or more holding tank(s), not shown.

Heated oil chambers (16C,18C,20C) are each electrically heated to maintain the precise temperature for fractionation.

Uncondensed gas (20D) from fractional condenser (20) is sent to chilled condenser (22) where an absorption chiller (23), which may be operated by waste heat from a burner, chills the gas to about 5° C. Very light, condensable alkanes, such as pentane and hexane, are recovered in tank (24) and may be further stored in a dedicated tank, not shown.

Non-condensable gases (25) are routed to a compressor (26) and stored in a pressurized gas storage tank (27). Non-condensable gases (25) are utilized for generating power by turbine (28) and to provide process heat via burner (29). Burner (29) expels (36) into firebox (31), which is equipped with a multi-outlet chamber (32) that directs heat to desired destinations via control valve (6C) for pyrolysis chamber (6), valve (7C) for pyrolysis chamber (7), valve (8C) for pyrolysis chamber (8), valve (11A) for high temperature ceramic type particulate filter (11), valve (23A) for absorption chiller (23), valve (2C) for PCC chamber (2), valve (34A) for catalytic reactor (13), valve (34B) for catalytic reactor (14), valve (34C) for catalytic reactor (15), and exhaust valve (30) to atmosphere.

Exhaust gas return from all recipients of heat (35) is re-directed to compressor (33), which directs gas to multi-outlet chamber (32) where further heat recycling and emissions reduction is achieved.

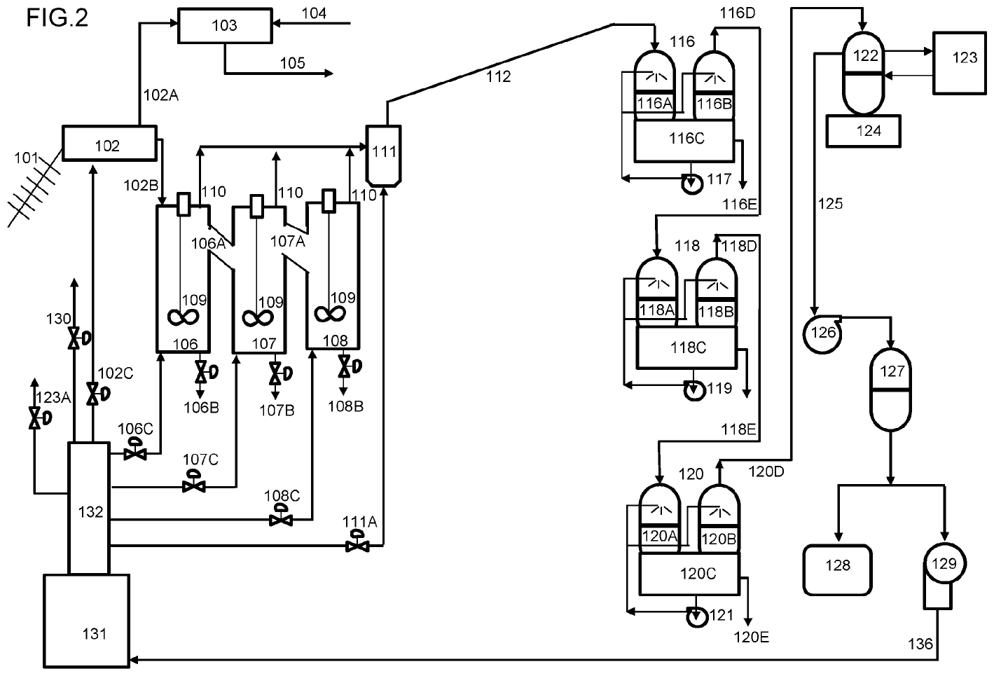

A related process of this disclosure will be better understood with reference to FIG. 2, which is a process diagram illustrating another pyrolysis process embodiment of this disclosure. Presorted, prewashed, and pre-shredded plastic, typically to size less than 1 inch in the largest dimension, mixed with an inorganic catalyst, such as one or more of FeO, Fe₂O₃, CaO, CaCO₃, MgO, Al₂O₃, ZnO, and Zeolites 5A, is fed into the system via conveyor belt (101). PCC chamber (102) is maintained at a temperature (typically about 150° C. to about 225° C.) sufficient to take the plastic beyond its glass transition temperature, but less than its vaporization temperature, resulting in a flowing, albeit viscous, fluid. Vent (102A) removes any volatile gases that are not beneficial to the process, such as Cl (as HCl) and F (as HF) resulting from heating halogenated plastics, such as PVCs. A jacketed vessel (103), containing functionalized polymeric adsorbent, is fluidly connected to cooling water loop (104). The adsorbent may be removed (105) and replaced periodically. The adsorbent has a weak base functionality that neutralizes the acidic gas, and the low level of organic vapors are adsorbed by the carbonaceous backbone. After removal (105), the adsorbent may be regenerated off site.

From PCC chamber (102) the liquified plastic waste is fed (102B) into pyrolysis chambers (106,107,108). Mixers/augers (109) keep the liquid plastic mixed in each pyrolysis chamber (106,107,108). Melted plastic flows from pyrolysis chamber (106) to each successive pyrolysis chamber (107,108) by overflow (107A,108A). From the first pyrolysis chamber (106), which is maintained at a temperature between about 250° C. and about 400° C., the liquid plastics mixture overflows (106A) to the second pyrolysis chamber (107), which is maintained at a temperature between about 300° C. and about 500° C., via an overflow channel (106A), and from second pyrolysis chamber (107) to third pyrolysis chamber (108), which is maintained at a temperature between about 400° C. and about 600° C., via overflow channel (107A).

Pyrolysis chambers (106,107,108) are each equipped with drains (106B,107B,108B, respectively) to clean the pyrolysis chambers (106,107,108) and evacuate any solids settled in pyrolysis chambers (106,107,108). Such solids may result from non-volatile additives added for the processing of the original plastics.

Pyrolysis gas (110) resulting from pyrolysis chambers (106,107,108) combines and is directed to a high temperature ceramic type particulate filter (111). Filtered pyrogas (112) from ceramic type particulate filter (111) is transferred to a cascading fractional condenser system comprising fractional condensers (116,118,120). Fractional condenser (116) includes two counter current packed bed columns in series (116A and 116B) and a heated oil chamber (116C) with recirculation pump (117) to spray the controlled temperature oil in the counter current packed bed columns (116A and 116B). Fractional condenser (116) condenses the heavy fractions, such as waxes, by maintaining the scrub oil temperature between about 350° C. to about 380° C. As the gas condenses, the volume in tank (116C) increases and overflow (116E) may be sent to one or more additional holding tank(s), not shown.

Uncondensed gas (116D) from fractional condenser (116) is sent to fractional condenser (118). Fractional condenser (118) includes two counter current packed bed columns in series (118A and 118B) and heated oil chamber (118C) with recirculation pump (119) to spray the controlled temperature oil in packed bed columns (118A and 118B). Fractional condenser (118) condenses the paraffin fraction (in this embodiment, a desired product fraction) by maintaining the scrub oil temperature between about 300° C. and about 360° C. As the gas condenses, the volume in heated oil chamber (118C) increases and overflow (118E) may be sent to one or more holding tank(s), not shown.

Uncondensed gas (118D) from fractional condenser (118) is sent to fractional condenser (120). Fractional condenser (120) includes two counter current packed bed columns in series (120A and 120B) and heated oil chamber (120C) with recirculation pump (121) to spray the controlled temperature oil in counter current packed bed columns (120A and 120B). Fractional condenser (120) condenses higher boiling point aromatics by maintaining the scrub oil temperature between about 160° C. and about 300° C. As the gas condenses, the volume in heated oil chamber (120C) increases and overflow (120E) may be sent to one or more holding tank(s), not shown.

Heated oil chambers (116C,118C,120C) are each electrically heated to maintain the precise temperature for fractionation.

Uncondensed gas (120D) from fractional condenser (120) is sent to chilled condenser (122) where an absorption chiller (123), which may be operated by waste heat from a burner, chills the gas to about 5° C. Very light, condensable alkanes, such as pentane and hexane, are recovered in tank (124) and may be further stored in a dedicated tank, not shown.

Non-condensable gases (125) are routed to a compressor (126) and stored in a pressurized gas storage tank (127). Non-condensable gases (125) may be utilized for generating power by a turbine (128) and to provide process heat via burner (129). The burner (129) expels (136) into firebox (131), which is equipped with a multi-outlet chamber (132) that directs heat to desired destinations via control valve (106C) for pyrolysis chamber (106), valve (107C) for pyrolysis chamber (107), valve (108C) for pyrolysis chamber (108), valve (111A) for high temperature ceramic type particulate filter (111), valve (123A) for absorption chiller (123), valve (102C) for PCC chamber (102), and exhaust valve (130) to atmosphere.

Exhaust gas return from all recipients of heat may be re-directed to multi-outlet chamber (132) where further heat recycling and emissions reduction is achieved.

### EXAMPLES

The following examples are provided to illustrate certain embodiments of the disclosure and are not to be construed as limitations on the disclosure, as set forth in the appended claims.

Example 1: 400 grams per hour of a 50-50 mixed plastics waste comprising polypropylene and polyethylene was mixed with 10%, by weight, FeO catalyst, and pyrolyzed using the processes of this disclosure including a three-chamber staged pyrolysis process with no catalytic reactor. The third pyrolysis chamber was maintained at 400° C. The total residence time in the system was 90 minutes.

The total liquid fuel recovered was approx. 74%, total non-condensable gases yield was approx. 26%. Liquid fuel composition recovered was Naphta (range=30%) and Diesel (range=70%).

Example 2: 400 grams per hour of a 50-50 mixed plastic feed comprising polypropylene and polyethylene was mixed with 10%, by weight, MgO catalyst, and pyrolyzed using the processes of this disclosure including a three-chamber staged pyrolysis process with no catalytic reactor. The third pyrolysis chamber was maintained at 390° C. The total residence time in the system was 90 minutes. The total liquid fuel recovered was approx. 79%, the total non-condensable gases yield was approx. 21%. Liquid fuel composition recovered was Naphta (range=61%), Diesel (range=38%), and wax (1%).

Example 3: 400 grams per hour of a 50-50 mixed waste comprising polypropylene and polyethylene was mixed with 10%, by weight, MgO catalyst, and pyrolyzed using the processes of this disclosure including a three-chamber staged pyrolysis process with no catalytic reactor. The third pyrolysis chamber was maintained at 430° C. The total residence time in the system was 90 minutes. The total liquid fuel recovered was approx. 75%, the total non-condensable gases yield was approx. 25%. Liquid fuel composition recovered was Jet Fuel/Kerosene (range=93%), Naphta (range=4%), and Diesel (range=2%).

While certain example embodiments have been described with reference to FIGS. 1 and 2, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of the inventions disclosed herein.

What is claimed is:

1. A method of processing plastic waste, comprising:
volatilizing light organics from plastic waste in a pre-conditioning chamber (PCC) maintained at a temperature between about 150° C. and about 225° C. to form a mixed plastic liquid;
directing the mixed plastic liquid from the PCC to a first pyrolysis chamber maintained at a temperature between about 250° C. and about 400° C. to form a homogenized plastics mixture;
directing the homogenized plastics mixture from the first pyrolysis chamber to a second pyrolysis chamber maintained at a temperature between about 300° C. and about 500° C. to form a partially cracked plastic mixture;
directing the partially cracked plastic mixture from the second pyrolysis chamber to a third pyrolysis chamber maintained at a temperature between about 400° C. and about 600° C. to form a pyrogas comprising C₁₂-C₂₆ alkanes;
feeding pyrogas from the third pyrolysis chamber into at least one of three catalytic reactors to produce a hydrocarbon stream from each catalytic reactor, wherein each catalytic reactor comprises a different catalyst;
directing hydrocarbons from the at least three catalytic reactors to a first of at least a first, second, and third fractional condenser, to form a light hydrocarbon vapor wherein each of the least first, second, and third fractional condensers are connected in series; and,
feeding the light hydrocarbon vapor from the third fractional condenser to a chilled water condenser to produce a pyrogas.

2. The method of claim 1, wherein inorganic halogen ions are emitted as HCl or HF gases in the PCC.

3. The method of claim 1, wherein the PCC is swept with a sweep gas to expel halogen acid gases.

4. The method of claim 3, wherein the sweep gas is nitrogen (N₂).

5. The method of claim 1, wherein the PCC comprises one or more gas vents.

6. The method of claim 5, wherein waste vapors are vented from the PCC through the one or more gas vents to an adsorbent.

7. The method of claim 6, wherein the adsorbent is a carbonized polystyrene crosslinked with divinylbenzene.

8. The method of claim 7, wherein the adsorbent is functionalized with tertiary amine group.

9. The method of any one of claims 6-8, wherein a housing for the adsorbent is jacketed with a cooling loop to maintain the temperature of the adsorbent below about 50° C.

10. The method of any one of claims 6-9, wherein the adsorbent is moistened with a periodic feed of water to the adsorbent.

11. The method of any one of claims 6-9, further comprising regenerating the adsorbent by contacting the adsorbent with a basic liquid.

12. The method of claim 11, wherein the basic liquid is a dilute NaOH.

13. The method of any one of claims 1-12, wherein the second pyrolysis chamber comprises an auger that mixes the homogenized plastics mixture.

14. The method of any one of claims 1-13, wherein the temperature in the second pyrolysis chamber is maintained at a temperature between about 350° C. and about 450° C.

15. The method of any one of claims 1-14, wherein the temperature in the second pyrolysis chamber is maintained at a temperature between about 375° C. and about 425° C.

16. The method of any one of claims 1-15, wherein a pyrogas comprising lower molecular weight alkane (C₁ to C₅) fuels is extracted from the second pyrolysis chamber.

17. The method of any one of claims 1-16, wherein CO₂ and CO are recovered from the second pyrolysis chamber.

18. The method of any one of claims 1-17, wherein the temperature in the third pyrolysis chamber is maintained at a temperature between about 450° C. and about 550° C.

19. The method of any one of claims 1-18, wherein the temperature in the third pyrolysis chamber is maintained at a temperature between about 475° C. and about 525° C.

20. The method of any one of claims 1-19, wherein the third pyrolysis chamber comprises a gas vent to remove any fugitive vapors.

21. The method of any one of claims 1-20, wherein the first, second, and third pyrolysis chambers each comprise a gas vent fluidly connected to a common manifold.

22. The method of any one of claims 1-21, wherein the pyrogas from the third pyrolysis chamber is filtered through a heated ceramic filter, to form a filtered pyrogas stream.

23. The method of any one of claims 1-22, wherein at least one catalytic reactor comprises a FeO catalyst.

24. The method of any one of claims 1-23, wherein at least one catalytic reactor comprises a MgO catalyst.

25. The method of any one of claims 1-24, wherein at least one catalytic reactor comprises a Zeolite A5 catalyst.

26. The method of any one of claims 1-25, wherein each of the at least first, second, and third fractional condenser comprise a recirculating fluid maintained at a temperature range of about 360° C. to about 400° C., about 250° C. to about 360° C., about 100° C. to about 250° C. respectively, wherein a fraction with boiling points lower than the temperature of the recirculating bath leave the fractional condenser as a gas, and a fraction with boiling points higher than the recirculating fluid condense and increase the volume of the recirculating fluid.

27. The method of claim 26, wherein the recirculating fluid is gravity drained to a holding tank.

28. The method of any one of claims 1-27, wherein each of the at least a first, second, and third fractional condenser comprise two packed columns connected in series, wherein gas is fed into the bottom of a first column and exits the top of a second column.

29. The method of any one of claims 1-28, wherein the first fractional condenser recirculates a fluid at a temperature range of about 300° C. to about 400° C.

30. The method of any one of claims 1-29, wherein the first fractional condenser recirculates a fluid at a temperature range of about 350° C. to about 370° C.

31. The method of any one of claims 1-30, wherein waxes are condensed in the first fractional condenser.

32. The method of claim 31, wherein the waxes are recycled back to the third pyrolysis chamber.

33. The method of any one of claims 1-32, wherein the second fractional condenser comprises a recirculating fluid maintained at the temperature of a desired paraffin.

34. The method of any one of claims 1-33, wherein the third fractional condenser comprises a recirculating fluid maintained at the temperature of aromatic hydrocarbons and other light fractions.

35. The method of any one of claims 1-34, wherein the third fractional condenser comprises a recirculating fluid maintained at the temperature of between about 160° C. and about 300° C.

36. The method of any one of claims 1-35, wherein the chilled water condenser is maintained at a temperature of about 5° C.

37. The method of any one of claims 1-36, wherein the pyrogas from the chilled water condenser comprises C₅ and C₆ hydrocarbon compounds.

38. The method of any one of claims 1-37, wherein the pyrogas from the chilled water condenser comprises non-condensable gases (NCGs).

39. The method of any one of claims 1-38, wherein the pyrogas from the chilled water condenser comprises at least one gas selected from hydrogen, methane, ethane, propane, and butane.

40. The method of any one of claims 1-39, further comprising feeding at least part of the pyrogas from the chilled water condenser to a flex fuel turbine to generate electrical power and waste heat.

41. The method of any one of claims 1-40, further comprising feeding at least part of the pyrogas from the chilled water condenser to fuel a low NOx burner to generate heat.

42. The method of claim 41, further comprising allocating heat from a heat distribution chamber from a fire box from the low NOx burner to a Proportional Integral Derivative (PID) thermostat loop.

43. The method of claim 42, further distributing heat via the PID thermostat loop to at least one of the three pyrolysis chambers, at least one catalytic reactor, and the chilled water condenser.

44. A method of processing a mixed plastic feed, comprising:
adding an inorganic catalytic material directly to a mixed plastic feed;
volatilizing light organics from the mixed plastic feed in a pre-conditioning chamber (PCC) maintained at a temperature between about 150° C. and about 225° C. to form a mixed plastic liquid;
directing the mixed plastic liquid from the PCC to a first pyrolysis chamber maintained at a temperature between about 250° C. and about 400° C. to form a homogenized plastics mixture;
directing the homogenized plastics mixture from the first pyrolysis chamber to a second pyrolysis chamber maintained at a temperature between about 300° C. and about 500° C. to form a partially cracked plastic mixture;
directing the partially cracked plastic mixture from the second pyrolysis chamber to a third pyrolysis chamber maintained at a temperature between about 400° C. and about 600° C. to form a pyrogas comprising C₁₂-C₂₆ alkanes;
directing hydrocarbons from the third pyrolysis chamber to a first of at least a first, second, and third fractional condenser to form a light hydrocarbon vapor, wherein each of the at least first, second, and third fractional condensers are connected in series; and,
feeding the light hydrocarbon vapor from the third fractional condenser to a chilled water condenser to produce a pyrogas.

45. The method of claim 44, wherein the inorganic catalytic material comprises a catalyst selected from the group consisting of FeO, Fe₂O₃, CaO, CaCO₃, MgO, Al₂O₃, ZnO, and Zeolites 5A.
